(19) United States
(12) Patent Application Publication
(10) Pub. No.: US 2024/0344207 A1
(43) Pub. Date: Oct. 17, 2024

(54) DEVICE FOR THE ELECTROLYTIC PRODUCTION OF GAS

(71) Applicant: Hoeller Electrolyzer GmbH, Wismar (DE)

(72) Inventor: Stefan HÖLLER, Lübeck (DE)

(21) Appl. No.: 18/580,672

(22) PCT Filed: Aug. 4, 2021
(86) PCT No.: PCT/EP2021/071805

§ 371 Date: Jan. 19, 2024

(51) Int. Cl. C25B 1/04; C25B 9/19; C25B 9/65; C25B 9/67; C25B 9/77; C25B 13/08; C25B 15/08

(52) U.S. Cl. CPC C25B 1/04; C25B 9/19; C25B 9/65; C25B 9/67; C25B 9/77; C25B 13/08; C25B 15/083

(57) ABSTRACT

An electrolysis device includes two stacks (1) whose electrolysis cells (2) are clamped between an end plate (7) which has an exclusively mechanical function, and an end plate (6) which also serves for feeding in the reactant, the coolant and the discharge of the reaction products and the coolant. The two stacks (1) with regard to their polarity are constructed in a reverse manner and are connected in series in a manner such that the connection-leading end plates (6) and herewith also their connections are subjected to the same potential on operation.

### CROSS REFERENCE TO RELATED APPLICATIONS

This application is a United States National Phase Application of International Application PCT/EP2021/071805, filed Aug. 4, 2021, the entire contents of which are incorporated herein by reference.

### TECHNICAL FIELD

The invention relates to a device for the electrolytic generation of gas, in particular for generating hydrogen and oxygen from water. Such electrolysis devices are counted as belonging to the state of the art and consist of a multitude of electrolysis cells which are arranged in stacks and are connected in series. Channels with which the reactant and the mostly likewise required coolant are fed, pass through the stacks, wherein these channels which pass through the stacks mostly run perpendicularly or roughly perpendicularly, i.e. obliquely to the electrolysis cells, channel-connect each individual electrolysis cell, i.e. supply them with reactants and possibly a coolant, lead away the coolant again and are provided for the discharge of the reaction products. Concerning hydrogen electrolysis cells, pure water is fed in excess as the reactant and furthermore serves as a coolant, wherein the excess water thus the coolant is led away again. It is predominantly only hydrogen which is captured as a reaction product, and the oxygen is led away together with the excess water.

### BACKGROUND

Such electrolysis cells which are constructed into cell stacks, so-called stacks can be alkaline electrolysis cells, PEM electrolysis cells, high-temperature electrolysis cells, AEM electrolysis cells or the like. These electrolysis cells which are electrically connected in series and are arranged in a stacked manner have proven their worth, since the cells do not need to be individually subjected to voltage, but only the stack as a whole, so that the same current flows through each individual cell. The output of such a stack is not only dependent on the surface area of the electrolysis cells, but also on their number. The greater the number in a stack, the greater however is also the voltage which is to be applied to this. Herein, one always strives to maintain a high energy density in such electrolysis devices, in order to improve the effectiveness and the construction size. On the other hand, the supply of the cells through the channels and an adequate cooling must be ensured, to which there are limits with regard to the design. For this reason, in practice not only are electrolysis cells connected together into a stack, but stacks are also connected in parallel and in series, in order to meet these demands. There are also technical guidelines which in practice influence the design. Thus for example the low-voltage guideline which specifies the electrical safety requirements limits the feed voltage to maximal 1,500 Volts. Although there is no problem in also significantly exceeding this voltage level regarding technology, however more significant safety precautions then result.

One problem in applying such a high voltage is that the distilled water which is fed via the channels, although having an extremely low electrical conductivity, at these voltages however it is not negligible and is 0.055 μS/cm corresponding to 5×10-6 S/m. For this reason, via correspondingly long conduit paths it must be ensured that the electrical connection of the end plates of both cell stacks which is entailed by the series connection of the cell stacks and via which end plates the feed is effected, is of such a high resistance that a surface change by way of electro-oxidation due to the potential difference can be reliably ruled out even over the longer term. However, on the other hand long conduit paths are unfavorable since they enlarge the facility, increase the through-flow resistance due to this and can also be disadvantageous for the purity of the water which flows through.

### SUMMARY

Against this background, it is the object of the invention to provide a device for the electrolytic generation of gas of the previously mentioned construction type such that the aforementioned problems are avoided.

According to the invention, this object is achieved by a device with features which are disclosed herein. Advantageous embodiments of the invention are disclosed herein including in the description and the drawings.

The device according to the invention for the electrolytic generation of gas, in particular of hydrogen and oxygen from water, comprises a multitude of electrolysis cells which are arranged in a stacked-manner (in a stacked configuration) and are connected in series, with at least one channel for the feed of a reactant and/or a coolant, said channel running perpendicularly or obliquely to the electrolysis cells. According to the invention, the channel between two electrolysis cells which are connected directly in series is connected to a feed conduit which feeds the reactant and/or the coolant.

Herein, it is to be assumed that the channel which is connected to the feed conduit between two electrolysis cells which are connected directly in series leads either only the reactant or however the reactant together with the coolant.

The basic concept of the present invention is to allow the feeding-in of the reactant and/or the coolant, in particular the water, to be effected between two electrolysis cells which are connected directly in series, in order to ensure that the same potential is present there, in order in this manner to avoid the otherwise necessary long conduit paths and despite the compact construction manner, to ensure that no potential differences exist in the region of the feeding-in of the stack.

Herein, according to the invention, either the feeding-in can be effected in the middle of the stack or however by way of the end-plates of two stacks, wherein the feeding-in is effected such that the same potential prevails at each of the two end-plates at which the feeding-in is effected, i.e. that the electrolysis cells which bear on the end-plates are subjected to the same electrical potential.

The device according to the invention is preferably formed from electrolysis cells of the PEM construction type which are connected in series and are clamped between end plates into stacks, as is advantageously applied for the electrolytic generation of hydrogen and oxygen from water. The present invention however is not restricted to this construction type and the initially mentioned or other cells can also be applied, and other reactants with other reaction products can also be applied.

It is particularly advantageous if at least two cell stacks which are connected in series are provided, said stacks being of electrolysis cells which are arranged in a stacked manner and are electrically connected in the stack in series, for example as has been described initially, wherein each cell stack comprises at least one channel which passes through the stack, for the feed of the reactant and/or the coolant and each of these channels is connected to the feed conduit at only one side of the respective cell stack. With such a constellation, according to a further advantageous embodiment of the invention, one envisages arranging the channel connections of the two cells stacks which are electrically connected in series at the end side, at which the cell stacks are electrically connected to one another. It is to be understood that this arrangement is particularly advantageous if all channels are connected to the respective end plates, i.e. the other end plates have a purely mechanical holding function. This embodiment according to the invention herewith envisages arranging the end plates which are used for feeding-in, not on both stacks at the same side, but at different sides, so that the electrolysis cell which bears on the respective end plate is subjected to the same electrical potential on operation.

With regard to the design, it is particularly advantageous if the two cell stacks which are connected in series are arranged next to one another such that they are electrically connected to one another at the same side (at the same ends of the stacks). The electrical connection can then be effected on the shortest path through a preferably straight-lined conduction connection, for example through a sheet copper section. Herein, according to a further embodiment of the invention, the two cells stacks which are connected in series are arranged next to one another such that their channel connections are also arranged at the same side. This results in short paths for the channel connections which are to be connected to the feed conduit or to the discharge conduits and on the other hand in a short electrical connection, in order to connect the two stacks in series and finally in the electrical connections which are advantageously arranged close to the other side of the stacks.

Not only does a channel for the feed of reactant and/or for the feed of the coolant typically pass through the stacks, but the stacks expediently further comprise at least one channel for the discharge of a reaction product, for example hydrogen and a further channel for the discharge of the further reaction product, for example oxygen and for the discharge of the coolant. It is to be understood that with regard to the configuration, it is particularly favorable if all these channel connections are provided at one side of the respective cell stack, preferably on an end plate, so that in the case of cell stacks lying next to one another, the connections likewise lie next to one another at one side of both cell stacks.

It is particularly advantageous if each cell stack is clamped between end plates, and these end plates are arranged in an electrically insulated manner (in an electrically insulated configuration) with respect to the electrolysis cells. Herewith, a danger of a short circuit within the device is significantly reduced. The end plates are then advantageously connected to the earth (ground) potential, so that a voltage only prevails between the clamped electrolysis cells.

In order to feed the conduit paths, in particular for the reactant, thus in particular the water, on the shortest possible path, the respective channels for the feed of reactant which pass through the stack are led out at two cell stacks and are connected to a common feed conduit, said cell stacks being arranged next to one another and being electrically connected in series. It is to be understood that advantageously the channels for the discharge of the product gas and the channels for the discharge of the excess reactant, in particular the coolant are led together in the same manner.

In order, in the region of the electrical connection of the two stacks which are connected in series, to ensure in the shortest path that the end-side electrolysis cells are subjected to the sample potential, thus are electrically conductively connected to one another, the stacks are advantageously constructed and arranged such that they have an opposite polarity i.e. that concerning one stack, the end plate via which the channel connections are effected lies at the positive side of the first or last electrolysis cell, whereas concerning the adjacent stack this end plate lies at the negative side of the first or last electrolysis cell of this stack. Concerning such a preferred arrangement, with regard to design it is particularly advantageous if the two cells stacks which are arranged next to one another and are electrically connected to one another comprise a common end plate. By way of this, the conduit paths can be shortened further. An extremely compact construction shape of two cell stacks which are arranged directly next to one another results. Herein, both cell stacks are advantageously configured such that all channel connections are effected through this one common end plate, i.e. that each cell stack comprises at least one channel for the feed of water, at least one channel for the discharge of water and for the discharge of oxygen and at least one channel for the discharge of hydrogen, and these channels are advantageously coupled and conduit-connected by the one common end plate.

Advantageously, the principle according to the invention can also be realized by way of the two stacks which are connected in series forming a common stack and being clamped between two end plates which only have a mechanical function, wherein then a connection plate is then provided in the middle between the stacks, via which connection plate at least one reactant at feed-in, preferably however all fluid connections of the complete stack are arranged there.

The device according to the invention is advantageously constructed for the electrolytic generation of gas from electrolysis cells of the PEM construction type and thus generates hydrogen and oxygen from pure water.

The invention is hereinafter explained in more detail by way of embodiment examples which are represented in the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic circuit diagram of two electrolysis stacks that can be electrically connected to one another and are provided with features according to the invention;

FIG. 2 is a schematic view of a first embodiment according to the invention;

FIG. 3 is a schematic view of a second embodiment variant of the invention;

FIG. 4 is a schematic view of a third embodiment according to the invention;

FIG. 5 is a perspective view showing two cell stacks of the first embodiment variant according to the invention;

FIG. 6 is a front view of the cell stack according to FIG. 5;

FIG. 7 is a lateral view of the cell stack according to FIG. 5;

FIG. 8 is a perspective representation of two cells stacks with a common end plate according to a second embodiment variant;

FIG. 9 is a front view of the stack arrangement according to FIG. 8;

FIG. 10 is a lateral view of the cell stack arrangement according to FIG. 8; and

FIG. 11 is a section through one of the cell stacks according to FIG. 6, in a perspective representation.

### DESCRIPTION OF PREFERRED EMBODIMENTS

Referring to the drawings, an electrolysis device according to the invention is represented in FIG. 1, said device being constructed of two stacks of electrolysis cells, so-called stacks 1. Each stack 1 comprises a number of electrolysis cells 2 of the PEM (polymer electrolyte membrane) construction type. The construction of such a stack of electrolysis cells is counted as belonging to the state of the art and is described in WO 2019/228616 A1, which is referred to here inasmuch as this is concerned (WO 2019/228616 A1 is incorporated herein by reference).

The electrolysis cells 2 with bipolar plates which are arranged therebetween, in a manner bearing on one another, are layered into a stack and at the end side of the cells 2 are provided with an electrical connection plate 3 at one side of the stack and a connection plate 4 at the other side of the stack. The electrolysis cells 2 are connected in series between the connection plates 3 and 4, and insulating plates 5, to which end plates 6 and 7 connect are arranged at the side of the connection plates 3 and 4 respectively which is away from the cells 2, between which end plates the stack 1 of electrolysis cells 2 is mechanically clamped.

The necessary mechanical clamping is typically provided by a number of bolts which pass through the stack 1 and are tightened at the outer side of the end plates 6 and 7. Herein, the end plate 7 at one side of the stack 1 serves exclusively for the mechanical fastening, whereas the end plate 6 apart from the mechanical fastening also yet comprises connections 8, 9 and 10 which via channels which pass through the stack serve for the supply and removal to and from the individual electrolysis cells 2. The connection 8 is therefore provided for the feed of the reactant water. Water is fed in excess and simultaneously serves as a coolant. The product gas hydrogen is led away out of the stack 1 via the connection 9. The connection 10 is provided for leading away the product gas oxygen as well as the coolant, i.e. excess water.

Such a stack construction has proven its worth, and herein the number of electrolysis cells 2 is selected such that a voltage of maximal 750 Volts is to be applied between the connection plates 3 and 4. If an electrolysis device is constructed of two stacks 1 which are connected in series as in the present case and as is represented by way of FIG. 1, then the plus pole lies at the connection plate 3 of the stack 1 which is at the left in FIG. 1 and the minus pole of the device at the connection plate 4 of the right stack 1, wherein the connection plate 4 of the left stack 1 and the connection plate 3 of the right stack 1 are connected to one another by an electrical lead 11. The device is herewith designed to be operated at a maximal voltage of 1,500 Volts, so that it can be operated according to the guidelines for low voltage. This is only to be understood by way of example and in principle the construction can be designed for any desired voltage, be it that the number of electrolysis cells 2 in the stack 1 is increased or decreased or that more stacks 1 are connected to one another.

With regard to the embodiment, which is represented by way of FIG. 1, the channel connections are not shown in detail. Here, it is only the basic principle of the stacks 1 which are connected in series which is represented, with regard to which two stacks 1 are constructed with reversed polarization, so that on connection by the lead 11, it is ensured that the same potential prevails at the channel connections 8 of the two stacks 1. The conduit connections between a feed conduit 12 which is not represented in FIG. 1 and which leads pure water and feeds this to the stacks 1 at the connections 8 as a reactant and as a coolant can be designed as short as possible. The electrical resistance of the pure water which results according to the conduit length does not have to be considered with this arrangement since all connections 8 to 10 at the stack 1 are subjected to the same electrical potential.

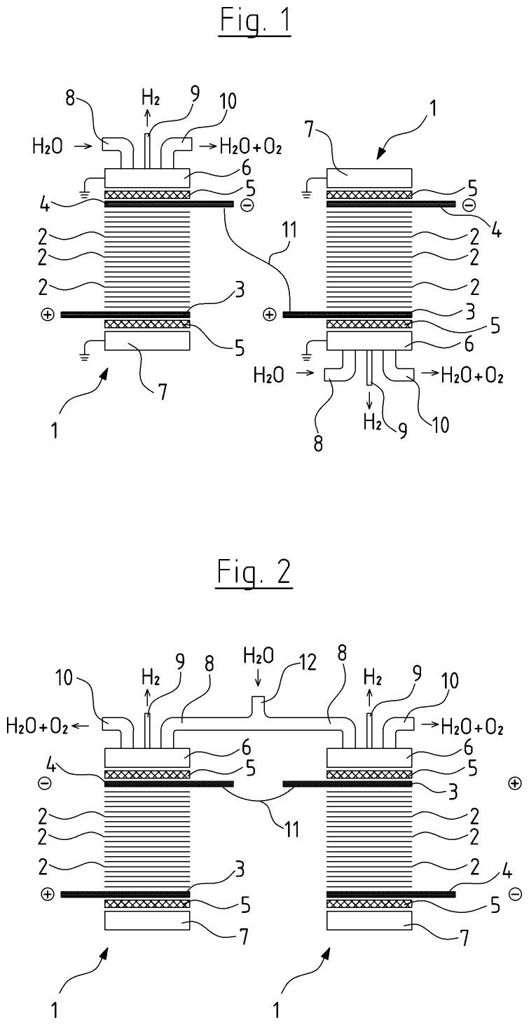

On account of this different arrangement of the electrolysis cells 2 in the stacks 1, the lead connection 11 of two stacks 1 which is advantageous per se can be realized, as is represented in FIG. 2. There, the two stacks 1 are arranged such that their connection-leading end plates 6 are arranged at one side and the end plates 7 which only act mechanically are arranged at the other side. By way of this, it is possible to configure the conduit connection between a common feed conduit 12 for the feed of the pure water to the connections 8 of the stacks 1 in a comparatively short manner, without running the danger of electro-oxidation or other electrolytic procedures being able to be activated in this region by way of potential differences. It is to be understood that the connections 9 for the discharge of the product gas hydrogen can be led together in the same manner, just as the connections 10, via which the excess water and the product gas oxygen are discharged.

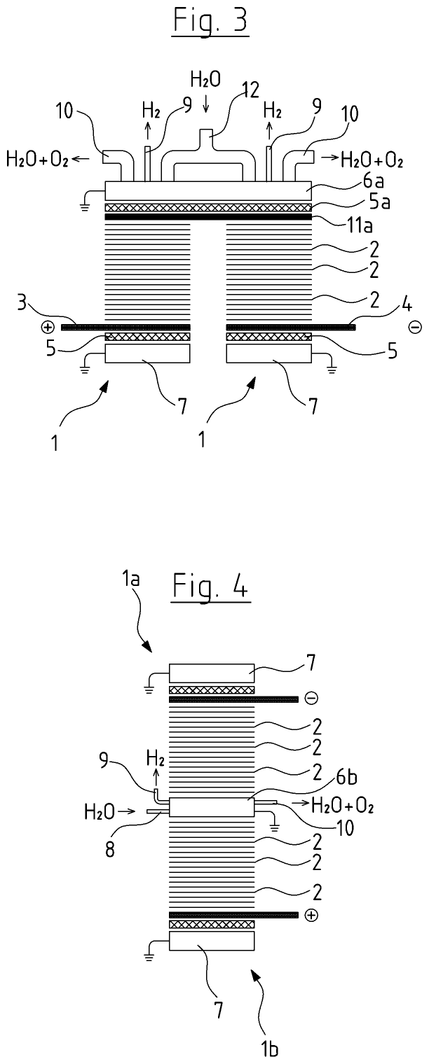

This arrangement which is represented by way of FIG. 2 can be configured in an even more compact manner if the two stacks 1 which are represented in FIG. 2 have a common end plate 6a in which either the connections 8, 9 and 10 are already led together or however concerning which these connections can be led together over a very short path as is represented in FIG. 3 by way of the connections 8. This arrangement is particularly compact and the end plates 7 of the two stacks 1 and the common end plate 6a are insulated with respect to the electrolysis cells 2 by way of insulating plates 5 and 5a and are subjected to earth (ground) potential. The conduit connections 8, 9 and 10 are provided at one side of the stacks 1 in the end plate 6a, and the electrical connections are led out at the other side, specifically through the connection plate 3 of the stack which is at the left in FIG. 3 and the connection plate 4 of the stack which is at the right in FIG. 3. The electrical connection of the stacks 1 is effected via a common copper plate 11a.

A further embodiment variant which follows the initially described principle of the feed-in of the water connection 8 being effected into both stacks 1 such that the firstly subjected electrolysis cells 2 are at the same potential, thus no voltage difference exists in this region, is represented by way of FIG. 4. The electrolysis device which is represented in FIG. 4 in principle likewise consists of two stacks 1a and 1b which are connected to one another amid the intermediate connection of a connection plate 6b. The clamping-in of the two stacks 1a and 1b is effected via two end plates 7 which both merely assume mechanical tasks and are insulated with respect to the electrolysis cells 2 of the stacks 1a and 1b via insulation plates 5. The connection plates 3 and 4 here are arranged close to the end plates 7, but at different end sides of the two stacks 1a and 1b.

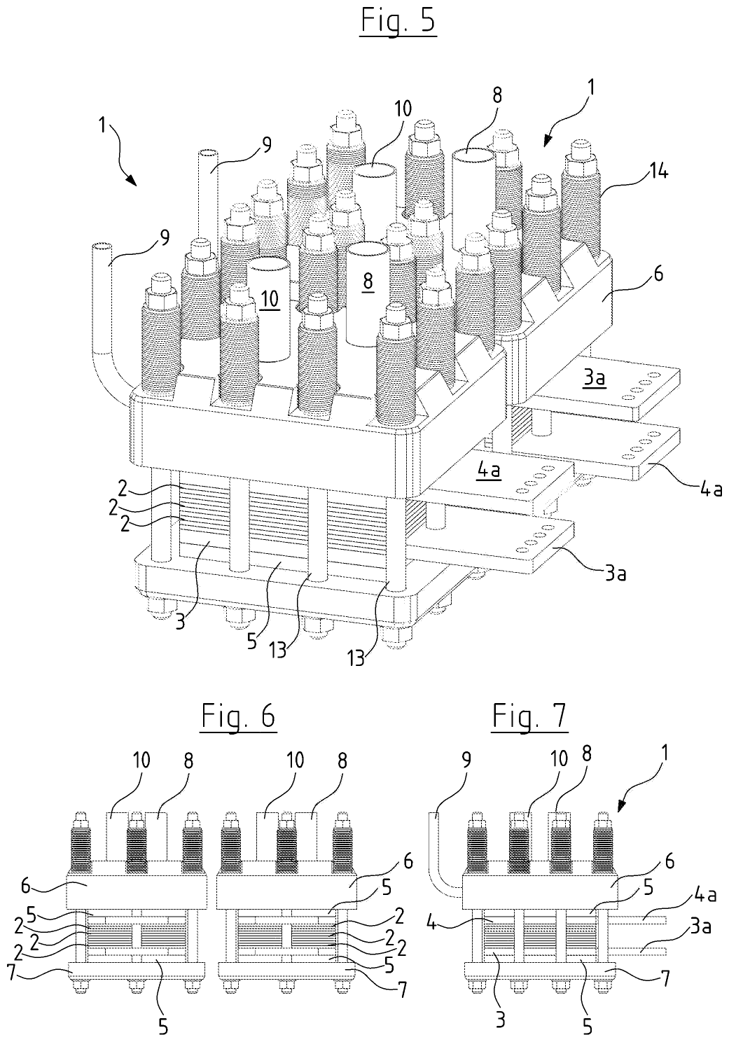

The basic construction of the electrolysis device is explained by way of FIGS. 1 to 4. FIGS. 5 to 7 show an embodiment variant according to FIG. 2 concerning which two equally constructed stacks 1 are arranged next to one another, wherein the electrolysis cells 2 are arranged in the individual stacks in a reversed manner, i.e. with an opposite polarity. The mechanical end plates 7 here are arranged on the lower side of the stack 1, whereas the end plates 6 which carry the connections 8 to 10 are on the upper side. What can be seen well is how the connections 8, 9 and 10 are led out of the end plates 7 to the rear or to the top out of the respective stacks, so that they can be connected to one another into a common conduit on the shortest path. The electrolysis cells 2 are mechanically connected by a multitude of tie rods 13 which amid the intermediate arrangement of disc spring assemblies 14 tighten the end plates 6 and 7 and herewith the electrolysis cells 2 which are arranged therebetween.

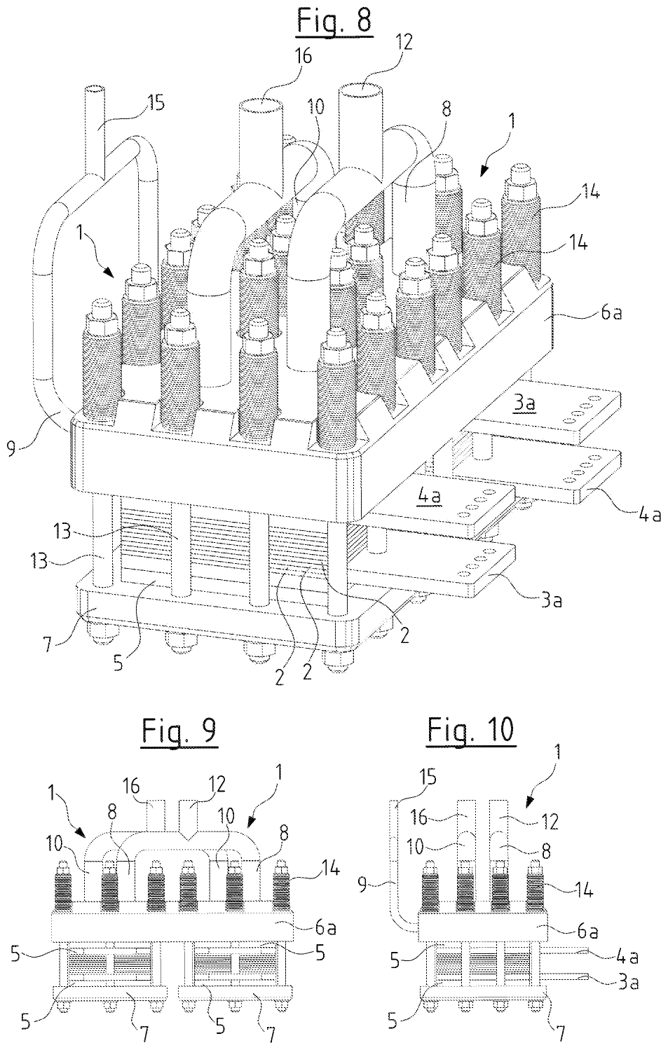

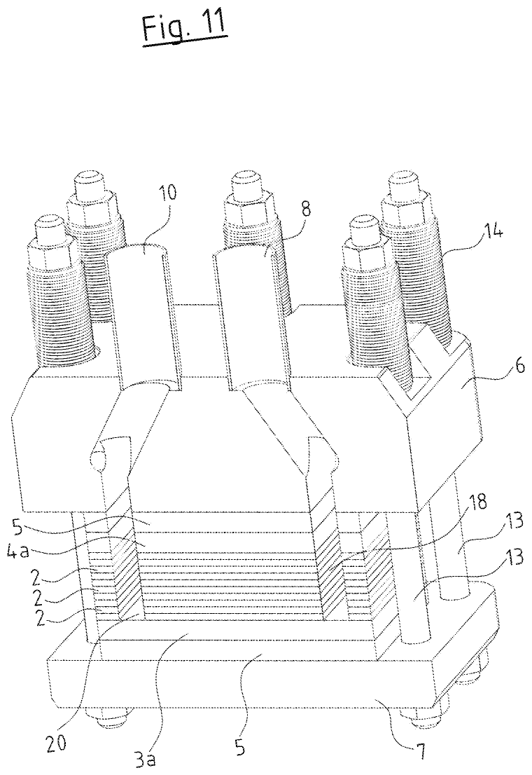

The embodiment variant which is represented by way of FIGS. 8 to 10 corresponds to the embodiment according to FIG. 3, i.e. two stacks 1 are provided with a common connection plate 6a. Concerning this embodiment variant, the conduit connections between the connections 8, 9 and 10 to the feed conduit 12 or to the discharging conduits 15 and 16 can be clearly recognized. This is an extremely compact design with short conduit connections which ensure a highly effective operation. The connection plates 3 and 4 are led out at the front side (front end) of the respective stack via tongues 3a and 4a respectively. Since the polarity in both stacks 1 runs in the reverse direction, only short copper sheets are necessary for the electrical connection by way of the lead 11 (FIG. 2), and these electrically connect the tongues 3a and 4a of the connection plates 3 and 4 which are at the top in the figures, to one another. The electrical connection of the stack 1 is effected via the tongues 3a and 4a of the connection plate 3 and 4 respectively which is at the bottom in the figures.

The inner construction of a stack 1 is to be recognized in FIG. 11. In particular, the channel 18 which runs (continuing from the connection 8) perpendicularly to the cell stack 1 and which serves for feeding pure water can be recognized. This water channel 18 is supplied with water via the feed conduit 12 which connects at the connection 8. The product gas oxygen and the excess water which serves as a coolant get into another channel 20 and there (continues) to the connection 10 wherein it is led away via a conduit 16. The channel for the product gas hydrogen (product gas hydrogen channel) is not to be seen in FIG. 11, and runs parallel to the channels 18 and 20.

While specific embodiments of the invention have been shown and described in detail to illustrate the application of the principles of the invention, it will be understood that the invention may be embodied otherwise without departing from such principles.

1. A device for the electrolytic generation of gas, in particular hydrogen and oxygen from water, the device comprising:
a multitude of electrolysis cells which are arranged in a stacked configuration and are connected in series with at least one channel for the feed of a reactant and/or a coolant, said channel running perpendicularly or obliquely to the electrolysis cells; and,
a feed conduit, wherein the channel between two electrolysis cells, which are directly connected in series, connects to the feed conduit which feeds the reactant and/or the coolant.

2. A device according to claim 1, wherein the multitude of electrolysis cells is configured to comprise at least at least two cell stacks which are electrically connected in series, said cell stacks being of the electrolysis cells which are arranged in a stacked configuration and are electrically connected in the stack in series, and each cell stack comprises at least one channel which passes through the stack, for the feed of the reactant and/or the coolant, wherein each of the channels is connected by a respective channel connection to the feed conduit at only one side of the respective cell stack, and the channel connections of the two cell stacks, said cell stacks being electrically connected in series, are arranged at the side at which the cell stacks are electrically connected to one another.

3. A device according to claim 2, wherein the two cell stacks, which are connected in series, are arranged next to one another such that the two cell stacks are electrically connected to one another at a same side.

4. A device according to claim 2, wherein the two cells stacks, which are connected in series, are arranged next to one another such that channel connections thereof are also arranged at a same side.

5. A device according to claim 2, wherein each cell stack comprises further channels for the discharge of the reaction products and/or the coolant and that all channels are connected at one side of the respective cell stack.

6. A device according to claim 2, further comprising end plates, wherein each cell stack is clamped between end plates which are arranged in an electrically insulated configuration with respect to the electrolysis cells.

7. A device according to claim 2, wherein each cell stack comprises the at least one channel as a water channel which passes through the respective stack, for the feed of water, and that the water channels of the two cell stacks, said cell stacks being arranged next to one another and connected electrically in series, are fed from a common conduit.

8. A device according to claim 2, further comprising a common end plate, wherein the two cell stacks have the common end plate.

9. A device according to claim 2, further comprising a common end plate, wherein the multitude of electrolysis cells is configured as at least two cell stacks and wherein the water channels of the cell stacks are fed via a common end plate.

10. A device according to claim 1, wherein each cell stack comprises at least one channel for the water feed, at least one channel for the water discharge and oxygen discharge and at least one channel for the hydrogen discharge and that the channels are conduit-connected and coupled by an end plate.

11. A device according to claim 2, wherein the two stacks which are connected in series and which together are clamped between two end plates are provided, wherein between the stacks a connection plate at least for the feeding-in of reactant is provided.

12. A device according to claim 1, wherein the electrolysis cells are PEM cells.
